(19) United States
(12) Patent Application Publication
(10) Pub. No.: US 2003/0180618 A1
(43) Pub. Date: Sep. 25, 2003

(54) Nonaqueous electrolyte secondary battery

(76) Inventors: Takao Inoue, Koube-shi (JP); Katsunori Yanagida, Itami-shi (JP); Naoya Nakanishi, Koube-shi (JP); Atsuhiro Funahashi, Suita-shi (JP); Toshiyuki Nohma, Kobe-shi (JP)

Correspondence Address: KUBOVCIK & KUBOVCIK, SUITE 710, 900 17TH STREET NW, WASHINGTON, DC, 20006

(21) Appl. No.: 10/392,083

(22) Filed: Mar. 20, 2003

(30) Foreign Application Priority Data
Mar. 25, 2002 (JP) 2002-083153

(51) Int. Cl. H01M 4/48; H01M 4/62; H01M 4/52; H01M 4/50

(52) U.S. Cl. 429/231.1; 429/223; 429/224; 429/231.5; 429/221; 429/220; 429/231; 429/231.3; 429/231.2; 429/217

(57) ABSTRACT

A nonaqueous electrolyte secondary battery having a positive electrode including a positive electrode active material, a negative electrode and a nonaqueous electrolyte comprising a solute dissolved in a solvent, the positive electrode active material is a mixture of a lithium-manganese composite oxide and a lithium-nickel composite oxide represented by LiNiₐM1_{1- a}O₂ (M1 being at least one element selected from the group consisting of B, Mg, Al, Ti, Mn, V, Fe, Co, Cu, Zn, Ga, Y, Zr, Nb, Mo and In, and a being 0<a≦1) and/or a lithium-cobalt composite oxide represented by LiCo_{b}M2_{1- b}O₂ (M2 being at least one element selected from the group consisting of B, Mg, Al, Ti, Mn, V, Fe, Ni, Cu, Zn, Ga, Y, Zr, Nb, Mo and In, and being 0<b≦1), and the nonaqueous electrolyte contains a phosphoric ester and an ether or an ester having a halogen substituted phenyl.

### FIELD OF THE INVENTION

The present invention relates to a nonaqueous electrolyte secondary battery that includes a positive electrode, a negative electrode and a nonaqueous electrolyte. Specifically, the present invention relates to an improvement of the positive electrode and nonaqueous electrolyte to obtain high battery capacity and to inhibit decomposition of the nonaqueous electrolyte during charge-discharge or storage under a state of charge.

### BACKGROUND OF THE INVENTION

A nonaqueous secondary battery having a high electromotive force that comprises a nonaqueous electrolyte and utilizes oxidation and reduction of lithium has recently been used as one of new type high output and high energy batteries.

In such a nonaqueous electrolyte secondary battery, a lithium-transition metal composite oxide which is capable of occluding and discharging lithium ion is used as a positive electrode active material. A lithium-cobalt composite oxide, for example, LiCoO₂, and the like, and a lithium-nickel composite oxide, for example, LiNio₂, and the like, are generally used.

However, cobalt and nickel, materials of a lithium-cobalt composite oxide and lithium-nickel composite oxide are expensive. A lithium-transition metal composite oxide containing a transition metal other than cobalt or nickel has been considered for use as a positive electrode active material. A lithium-manganese composite oxide, for example, LiMn₂O₄, and the like, that contains manganese of which there are reasonably rich deposits has recently been considered.

When a lithium-manganese composite oxide is used as a positive electrode active material, a capacity of a nonaqueous electrolyte secondary battery is smaller than that of a battery having a lithium-cobalt composite oxide or lithium-nickel composite oxide as a positive electrode active material. A charge-discharge voltage of the battery also becomes high and causes decomposition of a nonaqueous electrolyte and storage characteristics and charge-discharge characteristics are deteriorated.

There have been recent proposals to add a polymer having pyridyl group to a positive electrode active material comprising a manganese oxide or a lithium-manganese composite oxide to prevent deterioration of the positive electrode active material (Japanese Patent Laid-open Publication No. 11-238512), to use a mixture of a lithium-manganese composite oxide and a lithium-nickel composite oxide as a positive electrode active material to prevent deterioration of the positive electrode active material and of an electrolyte (Japanese Patent No. 3024636), and to add a phosphoric acid ester to a nonaqueous electrolyte as well as to use a manganese oxide or a lithium-manganese composite oxide as a positive electrode active material to prevent deterioration of the positive electrode active material and of the electrolyte (Japanese Patent Laid-open Publication No. 11-233140).

However, even if these improvements are used, capacity of a nonaqueous electrolyte secondary battery having a lithium-manganese composite oxide cannot be sufficiently improved, and deterioration of a positive electrode active material and a nonaqueous electrolyte cannot be sufficiently prevented.

### OBJECT OF THE INVENTION

An object of the present invention is to solve the above-described problems when a lithium-manganese composite oxide is used as a positive electrode active material for a positive electrode, and to prevent deterioration of a nonaqueous electrolyte during storage or charge of a battery so as to provide a nonaqueous electrolyte secondary battery having excellent storage characteristics as well as to obtain high capacity of the battery.

### SUMMARY OF THE INVENTION

To solve the above-described problems in a nonaqueous electrolyte secondary battery having a positive electrode including a positive electrode active material, a negative electrode and a nonaqueous electrolyte comprising a solute dissolved in a solvent, the positive electrode active material for the positive electrode is a mixture of a lithium-manganese composite oxide and a lithium-nickel composite oxide represented by the formula LiNiₐM1_{1- a}O₂ (wherein M1 is at least one element selected from the group consisting of B, Mg, Al, Ti, Mn, V, Fe, Co, Cu, Zn, Ga, Y, Zr, Nb, Mo and In, and a is 0<a≦1) and/or a lithium-cobalt composite oxide represented by the formula LiCo_{b}M2_{1- b}O₂ (wherein M2 is at least one element selected from the group consisting of B, Mg, Al, Ti, Mn, V, Fe, Ni, Cu, Zn, Ga, Y, Zr, Nb, Mo and In, and b is 0<b≦1), and the nonaqueous electrolyte contains a phosphoric ester and an ether or an ester having a halogen substituted phenyl.

### BRIEF DESCRIPTION OF THE DRAWINGS

FIG. 1 is a cross section of a nonaqueous electrolyte secondary battery prepared in Example 1 and Comparative Examples 1˜5.

FIG. 2 is a cross section of a nonaqueous electrolyte secondary battery prepared in Examples 2 and 3.

[Explanation of Elements]

1: positive electrode

2: negative electrode

3: separator

4: battery case

4a: positive electrode case

4b: negative electrode case

5: positive electrode current collector

6: negative electrode current collector

7: insulator packing

11: positive electrode

12: negative electrode

13: separator

14: battery can

15: positive electrode lead

16: positive electrode external terminal

17: negative electrode lead

18: insulator packing

### DETAILED EXPLANATION OF THE INVENTION

When a mixture of (1) lithium-manganese composite oxide and (2) lithium-nickel composite oxide and/or a lithium-cobalt composite oxide is used as the positive electrode active material, battery capacity is increased as compared with a battery in which a lithium-manganese composite oxide alone is used as a positive electrode active material. A charge-discharge voltage of the nonaqueous electrolyte secondary battery is lower than that of the battery in which the lithium-manganese composite oxide alone is used, and deterioration of a nonaqueous electrolyte during storage or charge of the battery is inhibited to improve storage characteristics and charge-discharge characteristics.

When the mixture described above is used as the positive electrode active material, a charge-discharge voltage becomes higher as compared to when a lithium-nickel composite oxide or a lithium-cobalt composite oxide is used alone. However, addition of the phosphoric ester and an ether or ester having a halogen substituted phenyl is helpful to inhibit decomposition of the nonaqueous electrolyte and to improve storage characteristics and charge-discharge characteristics of the battery.

As the lithium-nickel composite oxide and the lithium-cobalt composite oxide to be used for the positive electrode active material, it is preferable that the BET specific surface is in a range of 0.2˜10 m²/g, and an average diameter of particles is in a range of 1˜15 μm.

To broaden the discharge voltage range of the nonaqueous electrolyte secondary battery and to improve load characteristics, it is preferable that the lithium-nickel composite oxide described above is one represented by the formula LiNi_{c}Mn_{d}M3_{1- c- d}O₂ (wherein M3 is at least one element selected from the group consisting of B, Mg, Al, Ti, V, Fe, Co, Cu, Zn, Ga, Y, Zr, Nb, Mo and In, c is 0<c≦1, and d is 0.1<d). It is specifically preferred that M3 be at least one element selected from the group consisting of Al, Mg, Cr and Co. An oxide represented by LiNi_{c}Mn_{d}Co_{1- c- d}O₂ is further preferable.

As the lithium-manganese composite oxide to be used as the positive electrode active material, it is preferable to use an oxide having a spinel crystalline structure, and of which an average diameter of particles is in a range of 1˜15 μm. Specifically, it is further preferable to use an oxide represented by the formula Li₁₊ₑMn_{2- f}M4_{f}O₄ (wherein M4 is at least one element selected from the group consisting of B, Mg, Al, Ti, Mn, V, Fe, Co, Cu, Ni, Zn, Ga, Y, Zr, Nb, Mo, In and Cr, e is 0≦e≦0.5, and f is 0≦f≦1).

To improve characteristics of the positive electrode active material, it is preferable to mix the lithium-nickel composite oxide and/or lithium-cobalt composite oxide and the lithium-manganese composite oxide at a ratio in a range of 20:80˜80:20 by weight.

As the nonaqueous electrolyte to be used in the present invention, if the solute can be dissolved in the solvent and if the phosphoric ester and the ether or ester having a halogen substituted phenyl are included, there are no limitations regarding the solvent and solute.

As the ether or ester having a halogen substituted phenyl to be included in the nonaqueous electrolyte, a compound represented by formula (I):

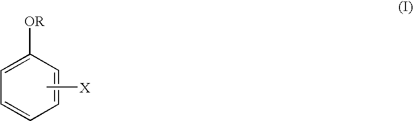

(wherein, R is alkyl or a group which forms an ester group with the oxygen, and X is halogen) can be used. Concretely, 2-fluoroanisole, 3-fluoroanisole, 4-fluoroanisole, 4-fluorophenyl acetate, and the like can be illustrated. 3-Fluoroanisole is preferably used.

As the phosphoric ester to be included in the nonaqueous electrolyte, a linear phosphoric acid ester represented by the formula (II):

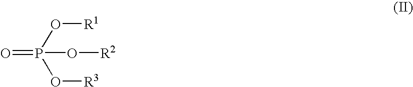

(wherein R¹˜R³ are the same or different and are alkyl of 1˜6 carbon atoms, and at least one of R¹˜R³ is methyl) or a cyclic phosphoric acid ester represented by the formula (III):

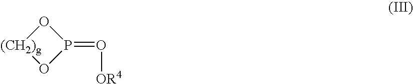

(wherein —(CH₂)_{g}— is a linear or branched alkylene, R⁴ is alkyl of 1˜6 carbon atoms, and g is an integer of 2˜8) can be used. There phosphoric esters can be used alone or in combinations thereof. Concretely, trimethyl phosphate, dimethylethyl phosphate, methyldiethyl phosphate, and the like, can be illustrated.

It is preferable to include an unsaturated cyclic ester having a carbon-to-carbon double bond, especially an unsaturated cyclic carbonate having a carbon-to-carbon double bond, in the nonaqueous electrolyte. Concretely, vinylene carbonate, 4,5-dimethylvinylene carbonate, 4,5-diethylvinylene carbonate, 4,5-dipropylvinylene carbonate, 4-ethyl-5-methylvinylene carbonate, 4-ethyl-5-propylvinylene carbonate, 4-methyl-5-propylvinylene carbonate, and the like can be illustrated. Vinylene carbonate is preferable.

To improve discharge characteristics of the nonaqueous electrolyte secondary battery, it is preferable to use the unsaturated cyclic ester having a carbon-to-carbon double bond in a range of 1˜7 weight % in the nonaqueous electrolyte.

As the solvent to be used for the nonaqueous electrolyte, solvents which are generally known for such use can be used. Cyclic carbonates, for example, ethylene carbonate, propylene carbonate, butylene carbonate, and the like; chain carbonates, for example, dimethyl carbonate, ethylmethyl carbonate, diethyl carbonate, methylpropyl carbonate, ethylpropyl carbonate, methyisopropyl carbonate, and the like; chain esters, for example, methyl acetate, ethyl acetate, propyl acetate, methyl propionate, ethyl propionate, and the like; cyclic carboxylates, for example, γ-butyrolactone, and the like; ethers, for example, tetrahydrofuran, 2-methyl tetrahydrofuran, 1,4-dioxane, 1,2-dimethoxyethane, 1,2-diethoxyethane, and the like; nitrites, for example, acetonitrile, and the like; amides, for example, dimethylformamide, and the like, can be used alone or in combinations thereof.

A known solute can be used as the solute to be dissolved in the nonaqueous electrolyte. A lithium compound, for example, LiPF₆, LiBF₄, LiCF₃SO₃, LiN (CₗF₂ₗ₊₁SO₂) (CₘF₂ₘ₊₁SO₂) (wherein l and m are integers of 1 or greater), LiC (CₚF₂ₚ₊₁SO₂) (C_{q}F_{2q+1}SO₂) (CᵣF₂ᵣ₊₁SO₂) (wherein p, q and r are integers of 1 or greater), and the like, can be used alone or in various combinations thereof.

A material known for use as a negative electrode active material can be used in the present invention. In addition to a lithium metal and a lithium alloy, for example, Li—Al, Li—In, Li—Sn, Li—Pb, Li—Bi, Li—Ga, Li—Sr, Li—Si, Li—Zn, LI—Cd, Li—Ca, Li—Ba, and the like, a carbon material, for example, graphite, coke, calcined organic substance, and the like, that are capable of occluding and discharging lithium ion, can be illustrated.

### DESCRIPTION OF PREFERRED EMBODIMENTS

Examples of a nonaqueous electrolyte secondary battery of the present invention are described below and are compared with those of comparative examples to show that an excellent battery capacity is obtained and decomposition of a nonaqueous electrolyte during storage at a condition of charging of the battery is inhibited to improve storage characteristics even if a lithium-manganese composite oxide is used as the positive electrode active material. It is of course understood that the present invention can be modified within the scope and spirit of the appended claims.

### EXAMPLE 1

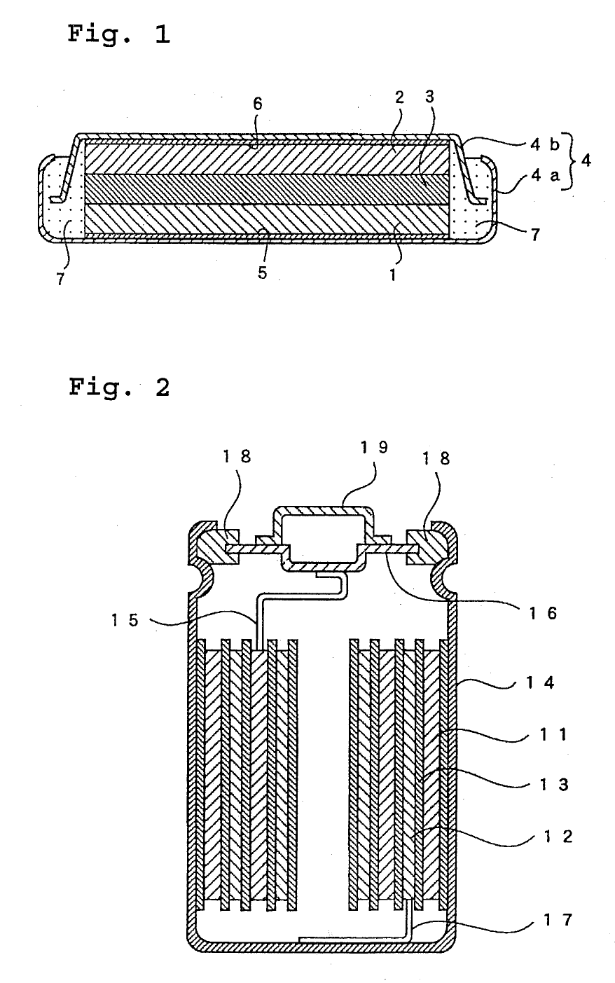

A flat coin shaped nonaqueous electrolyte secondary battery as shown in FIG. 1 was prepared using a positive electrode, a negative electrode and a nonaqueous electrode prepared as described below.

[Preparation of Positive Electrode]

A mixture of a lithium-nickel-cobalt-manganese composite oxide of the formula LiNi_{0.4}Co_{0.3}Mn_{0.3}O₂ and a lithium-manganese composite oxide of the formula Li_{1.15}Mn_{1.85}O₄ in a ratio of 1:1 by weight was used as a positive electrode active material.

The positive electrode active material, carbon black as an electrically conductive agent and polyfluorovinylidene as a binder were mixed in a ratio by weight of 95:5:5, and N-methyl-2-pyrrolidone was added to the mixture to prepare a slurry. The slurry was coated on one side of an aluminum foil having a thickness of 20 μm by a doctor blade, and dried, and was press rolled, and cut into a disc having a diameter of 20 mm to prepare a positive electrode.

[Preparation of Negative Electrode]

A lithium metal sheet having a thickness of 0.5 mm was cut into a disc having a diameter of 20 mm.

[Preparation of Nonaqueous Electrolyte]

Lithium hexafluorophosphate (LiPF₆) was dissolved in an amount of 1 mol/l in a solvent mixture of ethylene carbonate (EC), diethyl carbonate (DEC) and trimethyl phosphate (TMP) at a ratio by volume of 40:50:10, and then 3-fluoroanisole (3-FA) which is an ether having a halogen substituted phenyl was added in an amount of 1 weight % to prepare a nonaqueous electrolyte.

[Assembly of Battery]

The positive electrode 1 prepared above was attached to a positive electrode current collector 5, and the negative electrode 2 prepared above was attached to a negative electrode current collector 6. A separator 3 comprising polyethylene porous film impregnated with the nonaqueous electrolyte prepared above was placed between the positive and negative electrodes and was housed in a battery case 4 comprising a positive electrode case 4a and a negative electrode case 4b. The positive electrode 1 was connected to the positive electrode case 4a through the positive electrode current collector 5, and the negative electrode 2 was connected to the negative electrode case 4b through the negative electrode current collector 6. The positive electrode case 4a and the negative electrode case 4b were electrically insulated by an insulator packing 7 to prepare a nonaqueous electrolyte secondary battery of Example 1. A capacity of the negative electrode 2 made of lithium metal was designed to be larger than that of the positive electrode 1 in the battery.

### COMPARATIVE EXAMPLE 1

A nonaqueous electrolyte secondary battery of Comparative Example 1 was prepared in the same manner as Example 1 except that 3-fluoroanisole (3-FA) was not added to the nonaqueous electrolyte. That is, a solvent mixture of ethylene carbonate (EC), diethyl carbonate (DEC) and trimethyl phosphate (TMP) in a ratio by volume of 40:50:10 containing lithium hexafluorophosphate (LiPF₆) in an amount of 1 mol/l was used as the nonaqueous electrolyte in Comparative Example 1.

### COMPARATIVE EXAMPLE 2

A nonaqueous electrolyte secondary battery of Comparative Example 2 was prepared in the same manner as Example 1 except that only the lithium-nickel-cobalt-manganese composite oxide LiNi_{0.4}Co_{0.3}Mn_{0.3}O₂ was used as a positive electrode active material and the lithium-manganese composite oxide Li_{1.15}Mn_{1.85}O₄ was not included in the positive electrode active material.

### COMPARATIVE EXAMPLE 3

A nonaqueous electrolyte secondary battery of Comparative Example 3 was prepared in the same manner as Example 1 except that only the lithium-nickel-cobalt-manganese composite oxide LiNi_{0.4}Co_{0.3}Mn_{0.3}O₂ was used as a positive electrode active material and the lithium-manganese composite oxide Li_{1.15}Mn_{1.85}O₄ was not included in the positive electrode active material, and 3-fluoroanisole (3-FA) was not added to the nonaqueous electrolyte.

### COMPARATIVE EXAMPLE 4

A nonaqueous electrolyte secondary battery of Comparative Example 4 was prepared in the same manner as Example 1 except that only the lithium-manganese composite oxide Li_{1.15}Mn_{1.85}O₄ was used as a positive electrode active material and the lithium-nickel-cobalt-manganese composite oxide LiNi_{0.4}Co_{0.3}Mn_{0.3}O₂ was not included in the positive electrode active material.

### COMPARATIVE EXAMPLE 5

A nonaqueous electrolyte secondary battery of Comparative Example 5 was prepared in the same manner as Example 1 except that only the lithium-manganese composite oxide Li_{1.15}Mn_{1.85}O₄ was used as a positive electrode active material and the lithium-nickel-cobalt-manganese composite oxide LiNi_{0.4}Co_{0.3}Mn_{0.3}O₂ was not included in the positive electrode active material, and 3-fluoroanisole (3-FA) was not added to the nonaqueous electrolyte.

Then, the nonaqueous electrolyte secondary batteries prepared in Example 1 and Comparative Examples 1 to 5 were charged at a constant current of 0.75 mA/cm² at a temperature of 25° C. until an electric potential of 4.3 V was reached, and were discharged at a constant current of 0.75 mA/cm² until an electric potential of 3.0 V was reached, and discharge capacities per 1 g of the positive electrode active materials (Y1) (mAh/g) were measured. The results are shown in Table 1.

Then each battery was discharged at a constant current of 0.75 mA/cm² to 20% capacity (Y2) (mAh/g) of Y1, i.e., a battery state of charge (SOC) became 20%, at a temperature of 25° C., and was stored for 10 days in a constant temperature bath at 45° C. After storage, the batteries were discharged at a constant current of 0.75 mA/cm² to an electric potential of 3.0 V at a temperature of 25° C., and discharge capacities per 1 g of the positive electrode active materials (Y3) (mAh/g) were measured to obtain self discharge rates (%). The results are shown in Table 1.

Self discharge rates (%)=(Y2−Y3)/Y2×100

TABLE 1

| | | | | Self |
|---|---|---|---|---|
| | Positive | | | Discharge |
| | Electrode Active | Nonaqueous | Y1 | Rate |
| | Material | Electrolyte | (mAh/g) | (%) |
| Example 1 | LiNi_{0.4}Co_{0.3}Mn_{0.3}O_{2 +} | EC + DEC + | 130 | 10 |
| | Li_{1.15}Mn_{1.85}O₄ | TMP + 3-FA | | |
| Comparative | LiNi_{0.4}Co_{0.3}Mn_{0.3}O_{2 +} | EC + DEC + | 130 | 30 |
| Example 1 | Li_{1.15}Mn_{1.85}O₄ | TMP | | |
| Comparative | LiNi_{0.4}Co_{0.3}Mn_{0.3}O₂ | EC + DEC + | 160 | 65 |
| Example 2 | | TMP + 3-FA | | |
| Comparative | LiNi_{0.4}Co_{0.3}Mn_{0.3}O₂ | EC + DEC + | 160 | 70 |
| Example 3 | | TMP | | |
| Comparative | Li_{1.15}Mn_{1.85}O₄ | EC + DEC + | 105 | 70 |
| Example 4 | | TMP + 3-FA | | |
| Comparative | Li_{1.15}Mn_{1.85}O₄ | EC + DEC + | 105 | 80 |
| Example 5 | | TMP | | |

The batteries of Example 1 and Comparative Example 1 that used the mixture of the lithium-nickel-cobalt-manganese composite oxide LiNi_{0.4}Co_{0.3}Mn_{0.3}O₂ and the lithium-manganese composite oxide Li_{1.15}Mn_{1.85}O₄ as the positive electrode active material had smaller discharge capacity Y1 as compared to the batteries of Comparative Examples 2 and 3 that used only the lithium-nickel-cobalt-manganese composite oxide LiNi_{0.4}Co_{0.3}Mn_{0.3}O₂ as the positive electrode active material, but had a higher discharge capacity Y1 compared to the batteries of comparative Examples 4 and 5 that used only the lithium-manganese composite oxide Li_{1.15}Mn_{1.85}O₄ as the positive electrode active material. The self discharge rates of the batteries of Example 1 and Comparative Example 1 were significantly lower than that of the batteries of Comparative Examples 2˜5.

When the batteries of Example 1 and Comparative Example 1 were compared, the battery of Example 1 in which 3-fluoroanisole (3-FA) was included in the nonaqueous electrolyte had a further reduced self discharge rate.

### EXAMPLE 2

A cylindrical nonaqueous electrolyte secondary battery having a diameter of 18 mm, a height of 650 mm and a capacity of 1.5 Ah as shown in FIG. 2 were prepared using the positive and negative electrodes and the nonaqueous electrolyte prepared below.

[Preparation of Positive Electrode]

A mixture of a lithium-nickel-cobalt-manganese composite oxide having the formula LiNi_{0.4}Co_{0.3}Mn_{0.3}O₂ and a lithium-manganese composite oxide having the formula Li_{1.15}Mn_{1.85}O₄ in a ratio by weight of 1:1 was used as a positive electrode active material.

The positive electrode active material, carbon as an electrically conductive agent and polyfluorovinylidene were mixed in a ratio by weight of 95:5:5, and N-methyl-2-pyrrolidone was added to the mixture to prepare a slurry. The slurry was coated on an aluminum foil having a thickness of 20 μm by a doctor blade, and dried, and was press rolled to prepare a positive electrode.

[Preparation of Negative Electrode]

Natural graphite powder was used as a negative electrode active material. The natural graphite powder and polyfluorovinylidene as a binder were mixed in a ratio by weight of 95:5, and N-methyl-2-pyrrolidone was added to the mixture to prepare a slurry. The slurry was coated on the both sides of a copper foil having a thickness of 20 μm by a doctor blade and dried, and was press rolled to prepare a negative electrode.

[Preparation of Nonaqueous Electrolyte]

Lithium hexafluorophosphate (LiPF₆) was dissolved in an amount of 1 mol/l in a solvent mixture of ethylene carbonate (EC), diethyl carbonate (DEC) and trimethyl phosphate (TMP) at a ratio by volume of 40:50:10, 3-fluoroanisole (3-FA) was added in an amount of 1 weight %, and vinylene carbonate was also added in an amount of 3 weight %, to prepare a nonaqueous electrolyte.

[Assembly of Battery]

A separator 13 comprising polypropylene porous film which is ion permeable was inserted between the positive electrode 11 and the negative electrode 12, and these were rolled spirally, and placed in a battery can 14. The nonaqueous electrolyte prepared above was poured into the battery can 14, and the can was sealed. The positive electrode 11 was connected to a positive electrode external terminal 16 through a positive electrode lead 15, and the negative electrode 12 was connected to the battery can 14 through a negative electrode lead 17. The positive electrode external terminal 16 and the battery can 14 were electrically separated by an insulation packing 18 to prepare a nonaqueous electrolyte secondary battery.

### EXAMPLE 3

A nonaqueous electrolyte secondary battery of Example 3 was prepared in the same manner as Example 2 except that vinylene carbonate was not included in the nonaqueous electrolyte. That is, the nonaqueous electrolyte included lithium hexafluorophosphate (LiPF₆) in an amount of 1 mol/l and 3-fluoroanisole (3-FA) in an amount of 1 weight % in a solvent mixture of ethylene carbonate (EC), diethyl carbonate (DEC) and trimethyl phosphate (TMP) at a ratio by volume of 40:50:10.

Each battery of Examples 2 and 3 was charged at a constant current of 500 mA at a temperature of 25° C., a room temperature condition, to 4.2 V, and was discharged at a current of 500 mA at a temperature of 25° C. to 3.0 V to measure discharge capacity Q1 (mAh).

Then, the nonaqueous electrolyte secondary batteries prepared in Examples 2 and 3 were charged at a constant current of 500 mA at a temperature of 25° C. until an electric potential of 4.2 V was reached, and were stored for 10 days in a constant temperature bath at 45° C. After storage, the batteries were discharged at a constant current of 500 mA to an electric potential of 3.0 V, were charged at a constant current of 500 mA to an electric potential of 4.2 V, and were discharged at a constant current of 500 mA at a temperature of 25° C. to an electric potential of 3.0 V. Then discharge capacities Q2 (mAh) were measured. Maintained capacities (%) were calculated by the following formula. The results are shown in Table 2.

Maintained capacity (%)=Q2/Q1×100

TABLE 2
Positive Electrode Active Material:
LiNi_{0.4}Co_{0.3}Mn_{0.3}O₂ + Li_{1.15}Mn_{1.85}O₄

| | Nonaqueous Electrolyte | Maintained Capacity (%) |
|---|---|---|
| Example 2 | EC + DEC + TMP + 3-FA + VC | 95 |
| Example 3 | EC + DEC + TMP + 3-FA | 90 |

The battery of Example 2 in which vinylene carbonate was also added to the nonaqueous electrolyte had improved maintained capacity as compared to the battery of Example 3 in which vinylene carbonate was not added to the nonaqueous electrolyte.

### ADVANTAGES OF THE INVENTION

A nonaqueous electrolyte secondary battery of the present invention uses a mixture of a lithium-manganese composite oxide and a lithium-nickel composite oxide and/or a lithium-cobalt composite oxide as a positive electrode active material. A capacity of the battery is increased compared to a battery in which only a lithium-manganese composite oxide is used as a positive electrode active material. A charge-discharge voltage of the battery of the present invention is higher than that of a battery in which only a lithium-manganese composite oxide is used as a positive electrode active material, decomposition of a nonaqueous electrolyte is inhibited during charge and discharge and storage at a condition of charging, and storage characteristics and charge-discharge cycle characteristics are improved.

Storage characteristics and charge-discharge characteristics of a nonaqueous electrolyte secondary battery of the present invention are also improved because a phosphoric ester and an ether or ester having a halogen substituted phenyl are included in the battery.

What is claimed is:

1. A nonaqueous electrolyte secondary battery comprising a positive electrode comprising a positive electrode active material, a negative electrode and a nonaqueous electrolyte comprising a solute dissolved in a solvent, the positive electrode active material for the positive electrode being a mixture of (1) a lithium-manganese composite oxide and (2) a lithium-nickel composite oxide represented by formula LiNiₐM1_{1- a}O₂, wherein M1 is at least one element selected from the group consisting of B, Mg, Al, Ti, Mn, V, Fe, Co, Cu, Zn, Ga, Y, Zr, Nb, Mo and In, and a is 0<a≦1, and/or a lithium-cobalt composite oxide represented by formula LiCo_{b}M2_{1- b}O₂, wherein M2 is at least one element selected from the group consisting of B, Mg, Al, Ti, Mn, V, Fe, Ni, Cu, Zn, Ga, Y, Zr, Nb, Mo and In, and b is 0<b≦1, and the nonaqueous electrolyte comprising (3) a phosphoric acid ester and (4) an ether or an ester having a halogen substituted phenyl.

2. The nonaqueous electrolyte secondary battery according to claim 1, wherein the lithium-nickel composite oxide and the lithium-cobalt composite oxide have a BET specific surface in a range of 0.2˜10 m²/g, and an average diameter of particles thereof in a range of 1˜15 μm.

3. The nonaqueous electrolyte secondary battery according to claim 1, wherein the lithium-nickel composite oxide is represented by formula LiNi_{c}Mn_{d}M3_{1- c- d}O₂, wherein M3 is at least one element selected from the group consisting of B, Mg, Al, Ti, V, Fe, Co, Cu, Zn, Ga, Y, Zr, Nb, Mo and In, c is 0<c≦1, and d is 0.1<d.

4. The nonaqueous electrolyte secondary battery according to claim 1, wherein the lithium-manganese composite oxide has a spinel crystalline structure, and an average diameter of particles thereof in a range of 1˜15 μm, and is represented by the formula Li₁₊ₑMn_{2-f}M4_{f}O₄, wherein M4 is at least one element selected from the group consisting of B, Mg, Al, Ti, Mn, V, Fe, Co, Cu, Ni, Zn, Ga, Y, Zr, Nb, Mo, In and Cr, e is 0≦e≦0.5, and f is 0≦f≦1.

5. The nonaqueous electrolyte secondary battery according to claim 1, wherein the ether or ester having a halogen substituted phenyl is represented by formula (I): 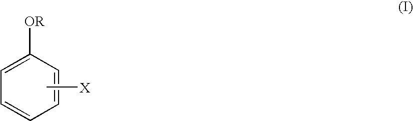
wherein, R is alkyl or a group which forms an ester group with the oxygen, and X is halogen.

6. The nonaqueous electrolyte secondary battery according to claim 1, wherein the ether or ester having a halogen substituted phenyl is 3-fluoroanisole.

7. The nonaqueous electrolyte secondary battery according to claim 5, wherein the ether or ester having a halogen substituted phenyl is 3-fluoroanisole.

8. The nonaqueous electrolyte secondary battery according to claim 1, wherein the phosphoric acid ester is represented by formula (II): 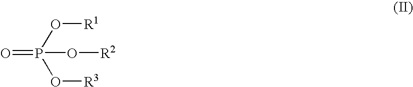
wherein R¹˜R³ are the same or different and are alkyl of 1˜6 carbon atoms, and at least one of R¹˜R³ is methyl.

9. The nonaqueous electrolyte secondary battery according to claim 5, wherein the phosphoric acid ester is represented by formula (II): 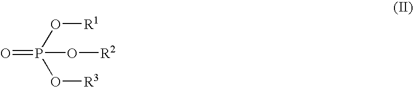
wherein R¹˜R³ are the same or different and are alkyl of 1˜6 carbon atoms, and at least one of R¹˜R³ is methyl.

10. The nonaqueous electrolyte secondary battery according to claim 8, wherein the phosphoric acid ester is trimethyl phophate.

11. The nonaqueous electrolyte secondary battery according to claim 9, wherein the phosphoric acid ester is trimethyl phophate.

12. The nonaqueous electrolyte secondary battery according to claim 1, wherein the phosphoric acid ester is a cyclic phosphoric acid ester represented by formula (III): 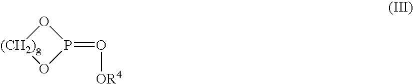
wherein —(CH₂)_{g}— is a linear or branched alkylene, R⁴ is alkyl of 1˜6 carbon atoms, and g is an integer of 2˜8.

13. The nonaqueous electrolyte secondary battery according to claim 5, wherein the phosphoric acid ester is a cyclic phosphoric acid ester represented by formula (III): 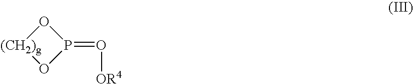
wherein —(CH₂)_{g}— is a linear or branched alkylene, R⁴ is alkyl of 1˜6 carbon atoms, and g is an integer of 2˜8.

14. The nonaqueous electrolyte secondary battery according to claim 1, wherein the nonaqueous electrolyte further comprises an unsaturated cyclic ester having a carbon-to-carbon double bond.

15. The nonaqueous electrolyte secondary battery according to claim 5, wherein the nonaqueous electrolyte further comprises an unsaturated cyclic ester having a carbon-to-carbon double bond.

16. The nonaqueous electrolyte secondary battery according to claim 1, wherein the positive electrode active material is a mixture of LiNi_{0.4}Co_{0.3}Mn_{0.3}O₂ and Li_{1.15}Mn_{1.85}O₄.

17. The nonaqueous electrolyte secondary battery according to claim 16, wherein the ether or ester having a halogen substituted phenyl is 3-fluoroanisole
